(19) United States
(12) Patent Application Publication
(10) Pub. No.: US 2010/0305870 A1
(43) Pub. Date: Dec. 2, 2010

(54) DETECTION OF GAS VOIDS IN PIPE USING GUIDED WAVE

(75) Inventors: Nicholas R. Camilli, Concord, NC (US); Steve Kenefick, Charlotte, NC (US); Michael J. Avioli, State College, PA (US); Joseph L. Rose, State College, PA (US); Roger L. Royer, State College, PA (US)

Correspondence Address: TREGO, HINES & LADENHEIM, PLLC, 9300 HARRIS CORNERS PARKWAY, SUITE 210, CHARLOTTE, NC, 28269-3797, US

(73) Assignee: ELECTRIC POWER RESEARCH INSTITUTE, Charlotte, NC (US)

(21) Appl. No.: 12/781,914

(22) Filed: May 18, 2010

Related U.S. Application Data
(60) Provisional application No. 61/181,349, filed on May 27, 2009.

(51) Int. Cl. G06F 19/00

(52) U.S. Cl. 702/24; 702/56

(57) ABSTRACT

A gas detection system for the detection of gas voids in piping systems. The gas detection system includes a transmitter, a receiver, and a computer. The transmitter is positioned at a designated point on a piping circuit and is adapted to transmit guided waves into the piping circuit. The receiver is positioned at a designated point distant from the transmitter and is adapted to receive the guided waves transmitted through the piping circuit by the transmitter. The computer analyzes and monitors the guided waves received by the receiver and determines the amount of gas in the piping circuit being analyzed.

This application claims the benefit of Provisional Application No. 61/181,349 filed on May 27, 2009.

### BACKGROUND OF THE INVENTION

The present invention relates to the field of gas accumulation detection. In particular, the invention relates to the detection of gas voids in piping systems.

Gas accumulation in both safety related and safety significant piping systems continues to be a challenge for nuclear power plant systems. More than 90 gas intrusion events have been reported, with approximately 30 of these events having occurred since 2005.

In January 2008, the Nuclear Regulatory Commission (NRC) issued Generic Letter 2008-01, “Managing Gas Accumulation in Emergency Core Cooling, Decay Heat Removal, and Containment Spray Systems.” The Generic Letter requests that each licensee evaluate its Emergency Core Cooling System (EGGS), Decay Heat Removal (DHR), and Containment Spray System (CSS), licensing basis, design, testing, and corrective actions to ensure that gas accumulation is maintained less than the amount that challenges operability.

As part of the Generic Letter request, plants were tasked with performing walk downs and reviews of piping and instrument drawings (P&ID's) to identify locations which pose a potential for gas accumulation. Design deficiencies such as uninstalled high point vents or improper location of high point vents, as well as, excessive construction tolerances has permitted gas voids to collect in piping systems. Gas voids may be caused by improper venting practices, leaking safety injection tanks or control volume tanks, leaking valves, and gas coming out of solution. Excessive gas voids (including air or nitrogen) in liquid bearing piping systems which feed pumps may cause degraded pump performance, and in a worst case scenario, they can cause the pump to air bind making the system inoperable.

Most plant technical specifications require monthly surveillance checks of the ECCS. These surveillance checks can be performed by venting or ultrasonic (UT) inspection. The presence of a vent valve may not be easily accessible and periodic venting may pose a risk to personal safety. In addition, venting of some valves leads to higher than wanted dose rates and presents the need for an online monitoring system.

Currently UT is the preferred method to detect, locate, and size gas voids due to its accuracy and availability in plants. Accuracy is an important element to gas detection because given the condition that a void is found, the plant must quantify the air void and possibly present an operability evaluation to the NRC. To use UT, the piping insulation must be removed at all locations where inspection is to be performed. UT can only be used in the areas where the probe is located. This can result in excess man-hours and accumulated dose to complete the task.

### BRIEF SUMMARY OF THE INVENTION

These and other shortcomings of the prior art are addressed by the present invention, which provides a method for detecting a specific amount of gas entrapment in a liquid filled pipeline based on the utilization of ultrasonic guided waves and specific waveform features.

According to one aspect of the present invention, a gas detection system includes a transmitter positioned at a designated point on a piping circuit and adapted to transmit guided waves into the piping circuit, a receiver positioned at a designated point distant from the transmitter and adapted to receive the guided waves transmitted through the piping circuit by the transmitter, and a computer for analyzing and monitoring the guided waves received by the receiver.

According to another aspect of the present invention, a method of detecting gas in a piping circuit includes the steps of calculating a set of dispersion curves for the piping circuit and using a gas detection system to transmit guided waves into the piping circuit. The method further includes the steps of using the gas detection system to receive the guided waves transmitted into the piping circuit and using the gas detection system to determine an amount of gas in the piping circuit.

According to another aspect of the present invention, a method of detecting gas in a piping circuit includes the steps of providing a gas detection system having a transmitter, a receiver, and a computer. The method further includes the steps of calculating dispersion curves for the piping circuit, using the transmitter to transmit guided waves into the piping circuit, using the receiver to receive the guided waves transmitted through the piping circuit, using the computer to calculate an analytic envelope, using the computer to calculate energy, and determining an amount of gas contained in the piping circuit.

### BRIEF DESCRIPTION OF THE DRAWINGS

The subject matter that is regarded as the invention may be best understood by reference to the following description taken in conjunction with the accompanying drawing figures in which:

FIG. 1 shows a guided wave A-scan display of two frequencies;

FIG. 2 shows a conventional ultrasonic method for gas detection;

FIG. 3 shows a guided wave ultrasonic method for gas detection according to an embodiment of the invention;

FIGS. 4A-C show guided wave displacements in a pipe;

FIG. 5 shows dispersion curves for a carbon steel pipe;

FIG. 6 shows Snell's law for determining incidence angle;

FIG. 7 shows a determination for spacing an axial linear array of comb probe elements;

FIG. 8 shows comb probe spacing necessary to achieve selected points on the dispersion curve;

FIG. 9 shows an envelope of a received signal;

FIG. 10 shows the process of obtaining an energy features;

FIG. 11 shows a phase velocity spectrum;

FIG. 12 shows the use of phase velocity spectrum to bracket a window for calculating an energy window;

FIG. 13 shows matched filtering for determination of an energy feature;

FIG. 14 shows an arrangement for a gas detection system according to an embodiment of the invention;

FIG. 15 shows a method of detecting a gas void according to an embodiment of the invention;

FIG. 16 shows a test arrangement for evaluation of guided waves;

FIG. 17 shows a time shift of transmission responses as a function of percent water volume in the test arrangement of FIG. 16 at 454 kHz;

FIG. 18 shows superposition of the fastest wave modes in the RF signal for 0% and 100% water in the test arrangement of FIG. 16;

FIG. 19 shows superposition of the fastest appearing mode in the RF signal for 25% and for 100% water in the test arrangement of FIG. 16;

FIG. 20 shows the amplitude of mode sensitive to water loading as a function of water volume for the test arrangement of FIG. 16;

FIG. 21 shows the amplitude of mode not sensitive to water loading as a function of water volume for the test arrangement of FIG. 16;

FIG. 22 shows a test pipe arrangement for the evaluation of guided waves;

FIGS. 23A and B show a transmitter configuration used for testing in the test arrangement of FIG. 22;

FIG. 24 shows mode amplitude for two frequencies as a function of water loading in the pipe of the test arrangement of FIG. 22;

FIG. 25 shows amplitude ratio of 400 kHz signals to 320 kHz signals as a function of water loading in the pipe of the test arrangement of FIG. 22;

FIG. 26 shows circumferential profile of guided wave amplitude at receiver location with the pipe of the test arrangement of FIG. 22 empty;

FIG. 27 shows circumferential profile of guided wave amplitude at receiver location with the pipe of the test arrangement of FIG. 22 full of water;

FIG. 28 shows a P&ID of a test arrangement for evaluation of guided waves;

FIG. 29 shows velocity dispersion curves generated for the test arrangement of FIG. 28;

FIG. 30 shows wave structures selected for gas intrusion in the test arrangement of FIG. 28;

FIG. 31 shows trend line fitted data of a total energy feature as a function of water removed from the test arrangement of FIG. 28;

FIG. 32 shows trend line fitted data of arrival time measured against a 0.01 volt threshold for the test arrangement of FIG. 28;

FIG. 33 shows trend line fitted data of a total energy feature as a function of water removed from the test arrangement of FIG. 28;

FIG. 34 shows trend line fitted data of arrival time measured against a 0.01 volt threshold for the test arrangement of FIG. 28;

FIG. 35 shows a test arrangement for evaluation of guided waves;

FIG. 36 shows RF waveforms obtained before and after propagating through a valve of the test arrangement of FIG. 35;

FIG. 37 shows a 470 kHz sample; and

FIG. 38 shows results from additional experiments on the test arrangement of FIG. 22.

### DETAILED DESCRIPTION OF THE INVENTION

Unlike conventional ultrasonic and eddy current techniques, guided wave ultrasonic nondestructive examination (NDE) technology presented herein, may be used to examine a relatively large area of a component from a single probe location. This results in the benefits of limited insulation removal and long distance remote examination of pipe. Guided wave may be permanently installed and used for on-line monitoring or for temporary attachment to piping for verifying water solid pipe. On-line monitoring not only eliminates the need to remove insulation, but also reduces man-hours and dose exposure.

Guided waves are ultrasonic waves guided by the confines of a structure, such as the inner and outer walls of a pipe. The ultrasonic waves generated in the component are reflected and mode-converted off its boundaries and eventually result in a guided wave that travels in the component. As with conventional ultrasonics, the area adjacent to the transducer where the wave is setting up has dead zone components, the extent of which is dependent on a number of issues, including frequency. These effects must be considered for the specific application.

The application of guided wave can be very complex: guided waves have multiple properties and variables that must be considered. There are several different guided wave modes that can be generated, including longitudinal, torsional, flexural, Lamb, shear-horizontal, and surface. Guided waves are generally dispersive-wave velocities can change and are a function of frequency, meaning that multiple waves may be present as thickness changes. In some applications, these properties can be used to examine a component, but they can also complicate their use in other applications. Some guided wave modes are significantly affected by the presence of liquids on the component boundaries. Although this can be used as an examination tool, it deters the use in other applications.

Guided waves may be introduced into pipe material with a variety of different wave properties. For instance, guided waves may be introduced to remain in the pipe wall without leaking into the water or air content of the pipe. In contrast to this, guided waves can also be introduced to leak into the water content of the pipe but not into the gas content of the pipe. In such cases, pipes containing a full volume of water will result in a large loss of sound energy as opposed to a pipe containing only air. Pipes containing partial volumes of water will have attenuation rates in between these two cases.

Guided wave energy is typically introduced into a material with a piezoelectric element, electromagnetic acoustic transducer (EMAT), or magnetostrictive sensor (MsS). Under ideal conditions, guided waves are capable of traveling significant distances within a component such as piping, tubing, plate, cable, or rod.

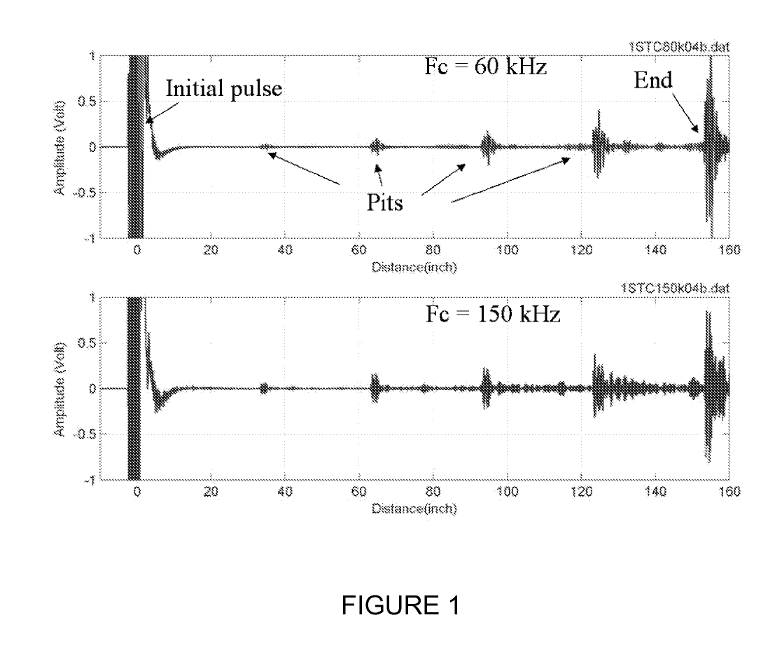

Data analysis methods are very dependent on the inspection application and are complicated by many factors. A typical data analysis screen display used for guided wave examination is a radio frequency (RF) A-scan presentation with signal amplitude on one axis and time on the other, FIG. 1.

The amplitude of the reflected signal is indicative of the amount of guided wave energy the probe receives and may be used to characterize the reflector. The time axis presents the time between the initial pulse and the reception of the reflected signal. The time may be used to calculate the distance of the reflector from the probe when the wave-mode group velocity is known, as is the case with the torsional wave mode. However, when dispersive guided wave modes are used, the sound velocity is dependent on frequency. The shape of the reflector signal may provide characterization information about the reflector. The frequency content of the signals may also be used to assist in characterizing a reflector.

Although there are similarities between conventional ultrasonics and guided waves, in relation to gas voids, there are many fundamental differences. These differences are highlighted in Table 1 below.

TABLE 1

| Conventional UT | Guided Wave |
|---|---|
| Accurate point measurement | Rapid screening of large |
| | inspection volumes |
| High Frequency (10-25 MHz) | Low Frequency (50-1000 kHz) |
| Short Wavelength | Long Wavelength |
| High Resolution | Lower Resolution |
| Transducer produces water level | GW is attenuated by presence |
| measurement by reflecting off of | of H2O on inside surface of pipe. |
| water surface or opposite pipe wall | Total attenuation is an integral |
| | effect of total surface area of |
| | H2O against pipe wall |
| Depends on how gas is distributed | Does not matter where gas is trapped |

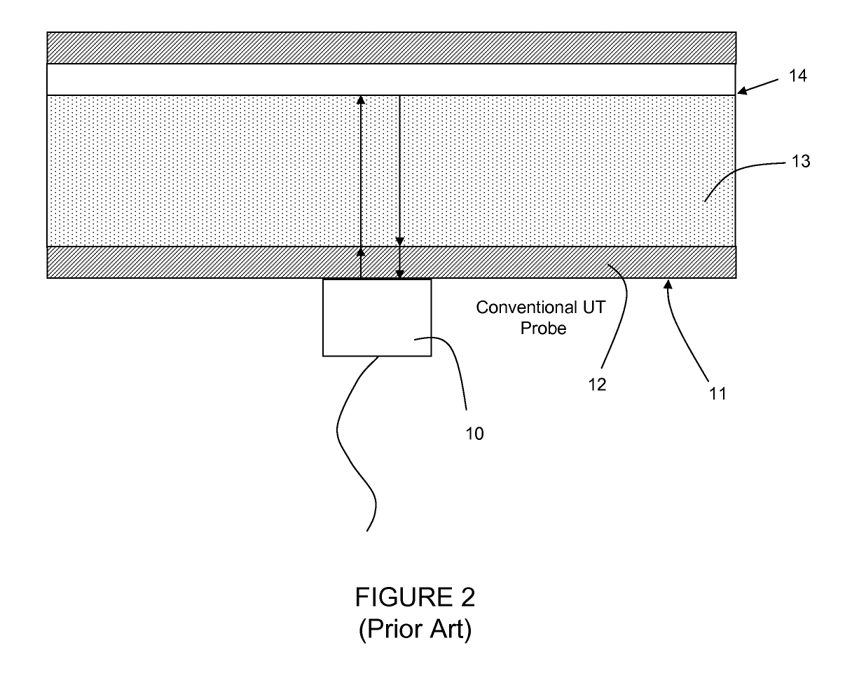

FIG. 2 shows a typical setup for determining water level using conventional ultrasonics. With an ultrasonics transducer 10 contacting a pipe 11, a bulk wave is sent from the transducer 10, through the pipe wall 12, through the liquid 13 to the liquid level 14, and then reflects back to the transducer 10. The total travel time is used to compute total travel length in the liquid.

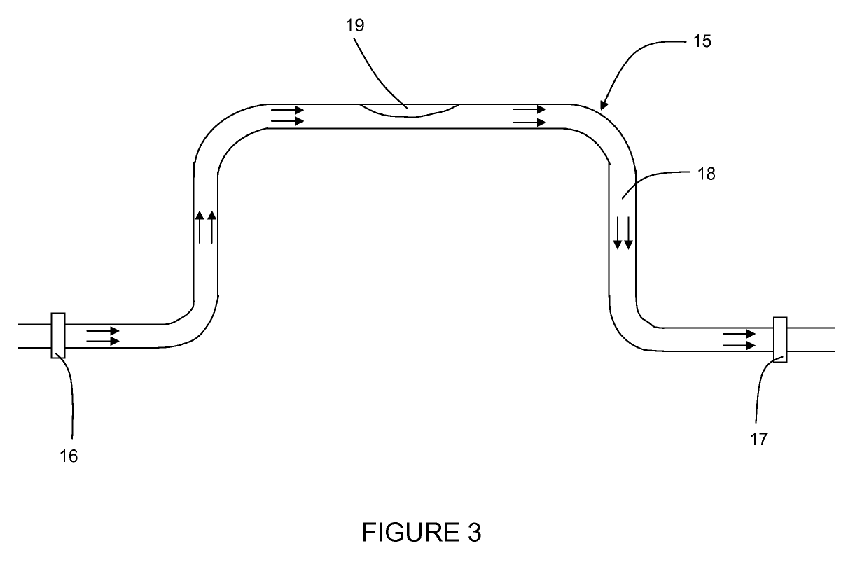

With guided wave ultrasonics, the guided wave travels through a pipe 15 from transmitter 16 to receiver 17, FIG. 3. As the guided wave travels, it leaks energy into the liquid 18. Energy lost into the liquid 18 depends on the water level. The amount of energy lost is measured to determine the total amount of air void 19.

For any natural wave guide structure, for example, a pipe with bend sections, a set of dispersion curves can be calculated. For every point on the dispersion curves there is a different wave structure, that is a different displacement variation across the thickness of the wave guide (pipe). In a fluid filled pipe, it is common knowledge to expect ultrasonic energy to leak into the fluid as the wave propagates from one position to another. Energy will not leak into a gas. This is easy to see if the inside surface of the pipe has a strong radial displacement component.

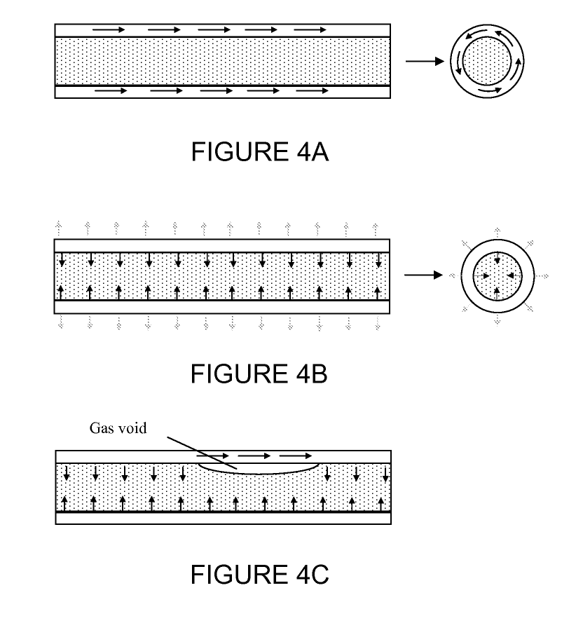

Guided waves may be produced in a pipe a number of ways by an assortment of ultrasonic wave generating transducers. Although this is true, specific modes of propagation within a pipe can only be generated with a specific angle of incidence, or in the case of a comb transducer, element spacing and excitation frequency. The modes needed for gas detection are those that have a significant radial displacement on the inside surface of the piping. See FIGS. 4A-C.

Energy easily leaks into a fluid due to the normal pressure loading of the fluid. On the other hand, if the displacement on the inside of the pipe is axial, the particle motion may be considered as trying to propagate shear energy into the fluid. Ideal non-viscous fluids do not support shear waves while viscous fluids can support a small amount of shear energy. As a result of this wave structure concept, two different test points, specific modes and frequency, on the dispersion curves, were found such that the wave velocity would change slightly for dry pipes versus wet pipes. That is, guided wave sensor design can be made to have maximum axial displacement on the inside surface of the pipe; hence, minimal leakage of energy. Conversely, maximum radial displacement will cause maximum leakage of energy. Optimal sensitivity to gas entrapment is achieved with maximum leakage; however, maximum penetration power is obtained with least leakage.

Sensitivity of a guided wave mode to the amount of liquid on the inside surface is optimized when the radial displacement component is a maximum. On the other hand, propagation length is longest when the axial component is maximized. Considering the trade-off between sensitivity and propagation length, practical application requires a mode to be excited that has optimal sensitivity, while still maintaining sufficient propagation length.

The guided wave mode and frequency determines the amount of radial and axial displacement components. In-plane displacements are shown propagating a pipe in FIG. 4A. Rather, if the pipe is totally gas filled or totally liquid filled, a major percentage of the input sound energy arrives at the receiver. Radial displacements are shown in FIG. 4B. As the sound energy propagates down the pipe, energy is lost into the liquid carried by the pipe. The presence of insulation would also absorb a negligible amount of energy. FIG. 4C shows what occurs when a gas void is present and contracting the interior pipe wall. As shown, more energy is transmitted since the leakage into the pipe cannot occur because the liquid has been displaced by the gas volume.

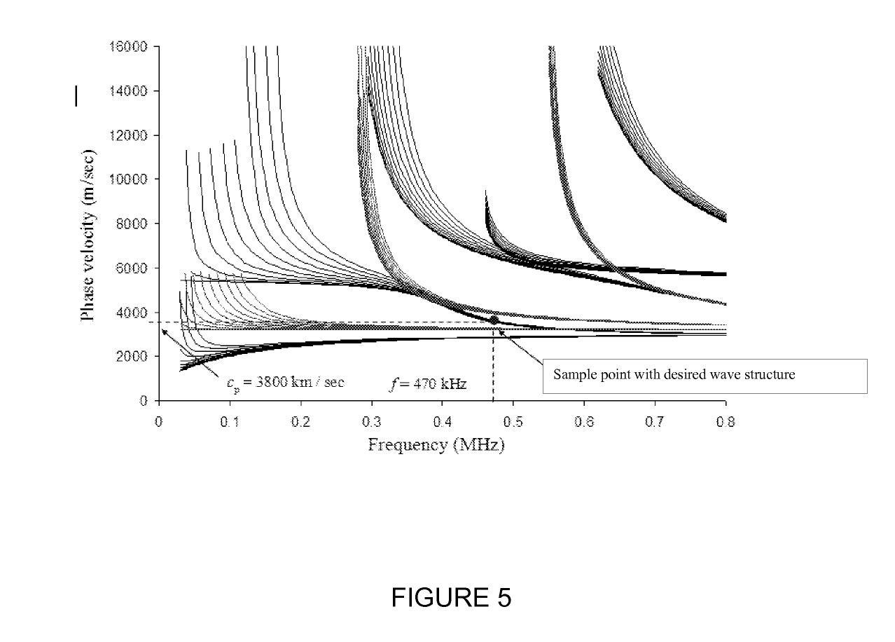

A pipe is typically specified by its outer diameter, wall thickness, and its material properties. Guided wave propagating modes are also functions of these parameters. Each pipe has an associated set of curves, called Dispersion Curves, that show the physically realizable modes that can exist. One set of curves are called phase velocity curves and the other, group velocity curves. For transducer specifications, only the phase velocity curves are necessary. Each point on a dispersion curve has associated with it the type of displacement, or wave structure, that will exist in the pipe wall for that (frequency, phase velocity) coordinate, FIG. 5. Wave structure determines the distribution of axial and radial propagation and their distribution across the wall thickness.

The desired feature for gas entrapment detection is a dominant axial displacement on the inside surface to improve overall penetration power. Due to the transmitter source influence, there is a phase velocity spectrum that allows sufficient energy to leak into the liquid. This provides an ability to find the presence of a gas pocket.

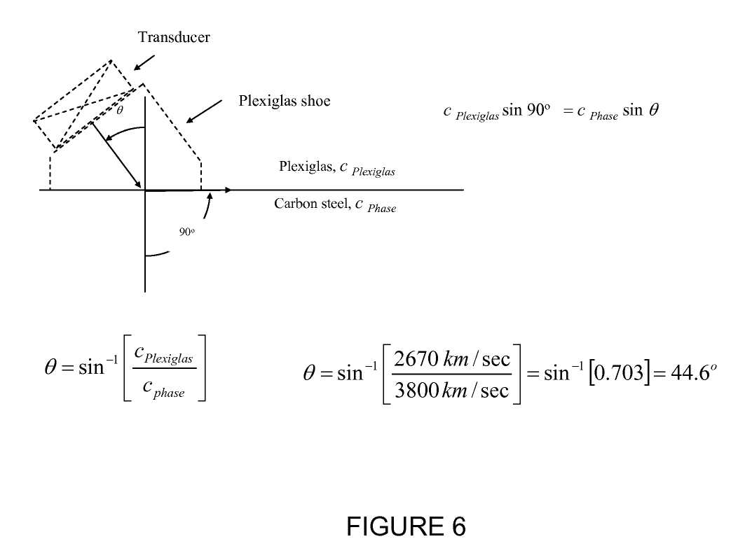

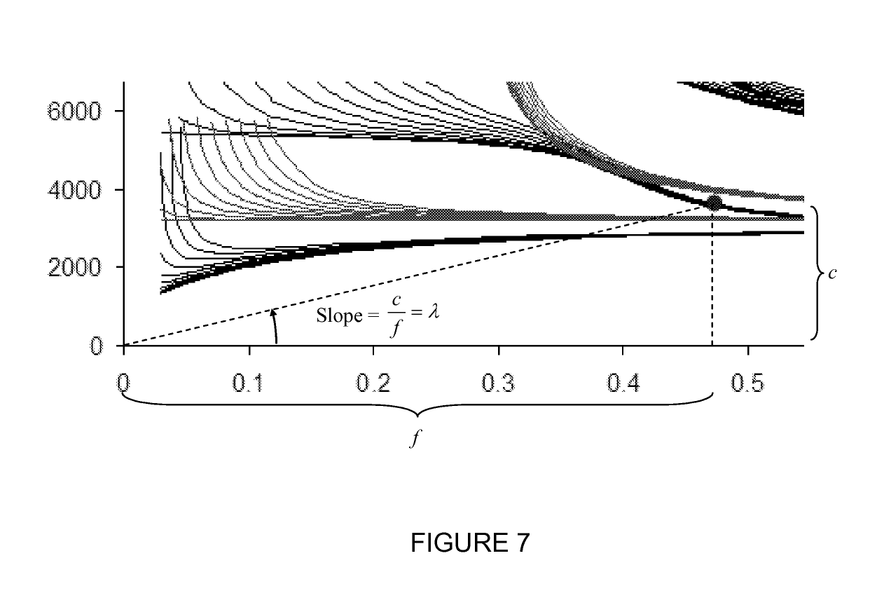

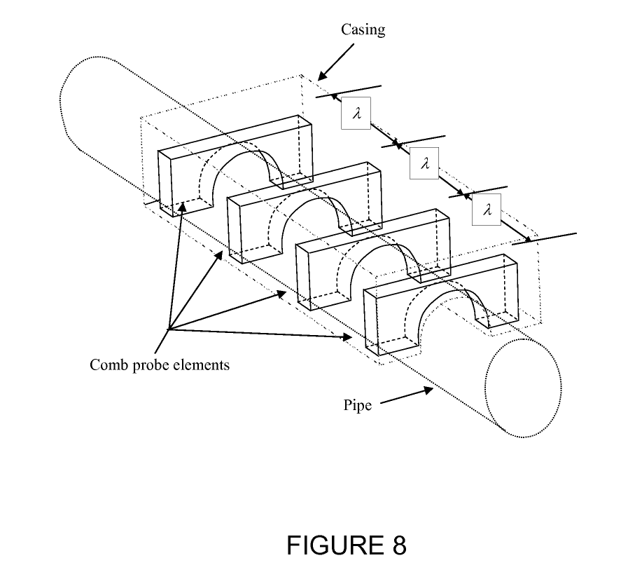

A sample coordinate, (470 kHz, 3800 m/sec), is shown in FIG. 5 for illustrative purposes. The angle of incidence for an angle beam transducer is calculated using Snell's law, FIG. 6. Assuming that Plexiglas is being used as the transducer shoe material, its velocity is 2670 km/sec. The velocity from the dispersion curve is 3800 km/sec. Alternatively, if a comb probe were used, FIGS. 7 and 8, the element (or tooth) spacing can be determined from the relation λ=cₚₕₐₛₑ/f.

To obtain the value of the energy, a couple of signal processing steps are necessary. The first step is the calculation of the analytic envelope of the received signal. The analytic envelope is calculated by taking the Hilbert transform of the received signal. Energy is calculated by integrating over time the square of the envelope. The energy is acquired by sequentially adding each successive portion of the squared envelope as a running sum:

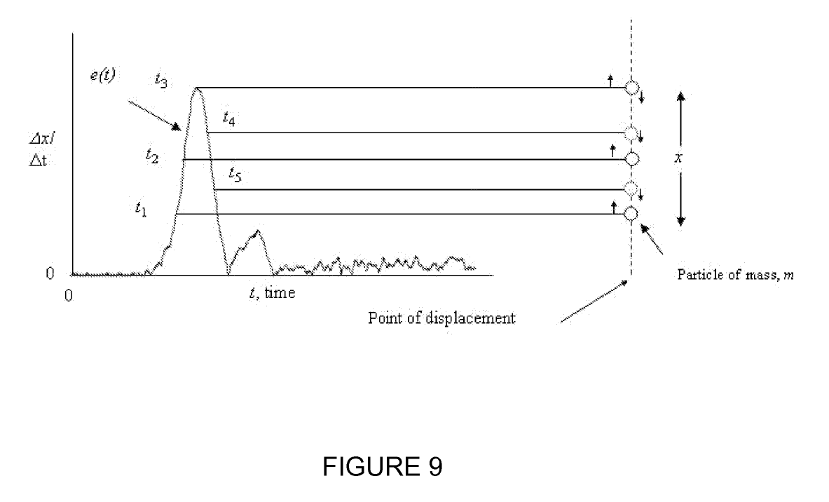

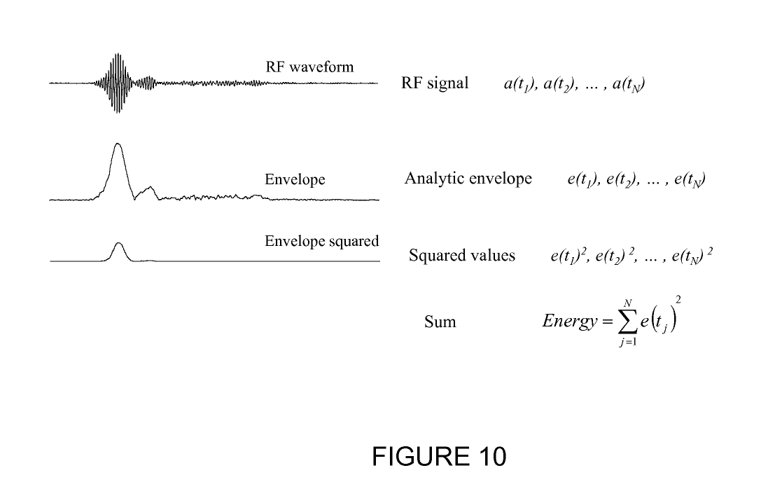

K=½mv²

where K is kinetic energy, m is mass, v is velocity. Since the mass of material being displaced at a point by an ultrasonic wave is a constant, i.e. K∝v². A signal's envelope is the variation of x, displacement, over time at a point. It is the velocity at that point where the energy is measured by the receiving transducer, FIGS. 9 and 10.

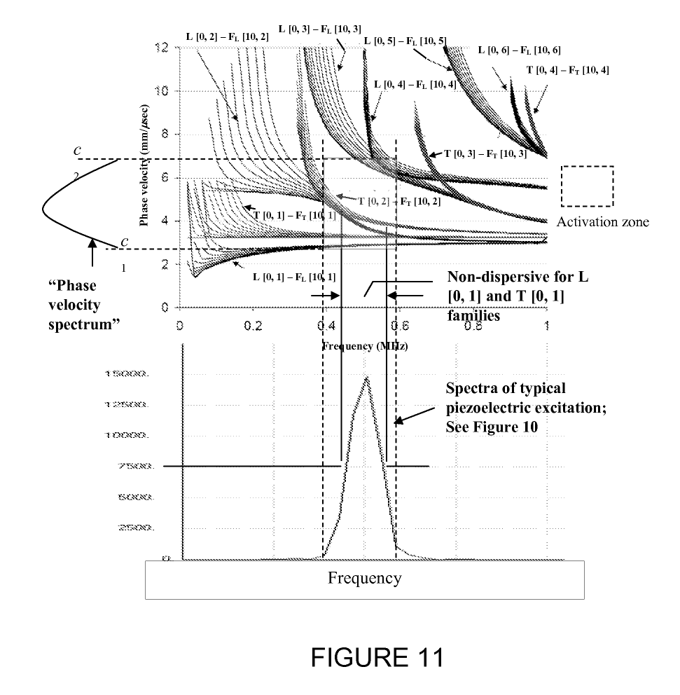

An example set of dispersion curves for pipe in general is illustrated in FIG. 11. In the case of a pulsed piezoelectric transducer that fully encircles the pipe, only the axisymmetric modes are very evident. Flexural modes are typically not propagated but can occur as a result of reflection from non-symmetric reflectors along a piping path. Choosing the frequency and phase velocity through angle of incidence allows for the excitation of a mode suitable for detecting gas voids.

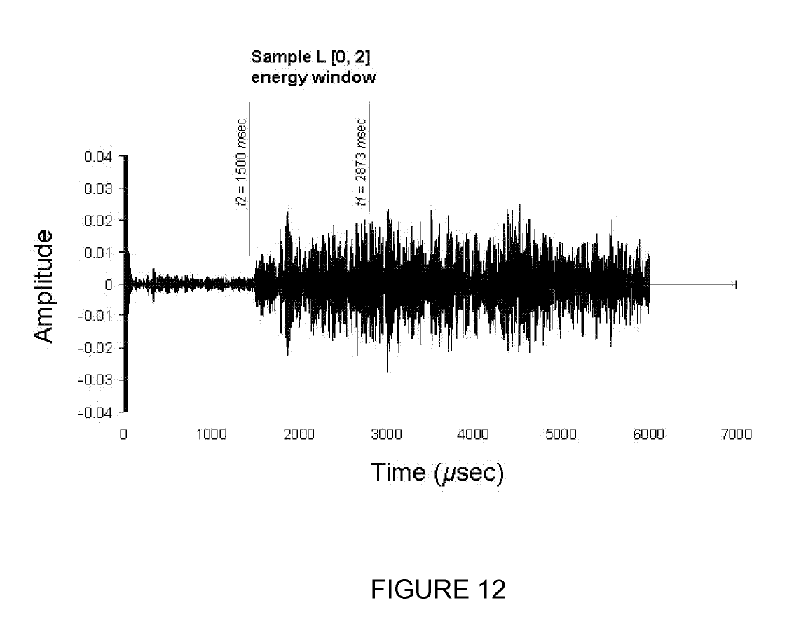

The excitation frequency range leads to a phase velocity distribution. The symbols c₂ and c₁ represent the highest and lowest expected velocities for a set of dispersion curves [pipe size] and excitation frequency range. The peak of the phase velocity spectrum is the expected mode velocity. The expected mode is then between c₁ and c₂. This means that the energy associated with mode (s) traveling at cₒ and c_{g2} will arrive at distance d, at t₁=d/c_{g1} and t₂=d/c_{g2}; d=distance between transmitter and receiver. c_{g1} and c_{g2} are the group velocities associated with the phase velocities c₁ and c₂. The energy we desire to measure is between t₁ and t₂. This is only a portion or a “window” on the entire received waveform. See FIG. 12.

For example, the L[0, 2] mode, a highly symmetric mode as desired, propagates ˜5.3 mm/μsec (0.209 in/μsec) at 150 kHz in carbon steel. In this example, the region is considered to be non-dispersive, i.e. c_{g1}=c₁ and c_{g2}=c₂. Say c₁=4.6 mm/x [0.181 in/x] and c₂=5.3 mm/sec [0.208 in/μsec]. Then, at 26 ft. for example, the window would be between, t₁=26*12 in./0.181 in/μsec=2,873 μsec, and t₂=26*12 in/0.208 in/μsec=1,500 μsec.

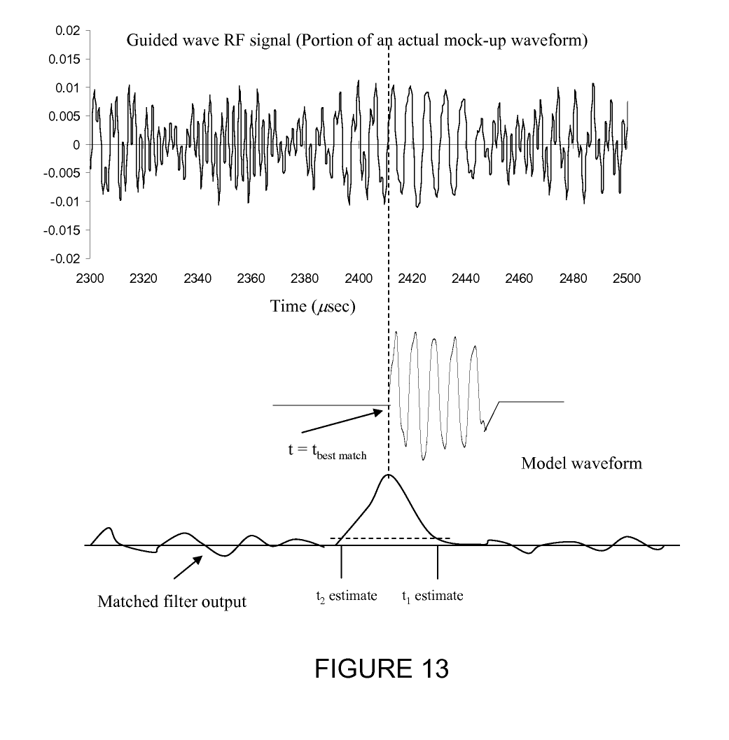

Locating the correct window is very important. Knowing the correct c₁ and c₂ may be challenging. Reasonable estimates can be obtained using “matched filtering”. Matched filtering presupposes a waveform shape for the mode of interest. Conceptually, this waveform is slid through the waveform at hand where it hopefully matches at some point(s) (time) with a wave pattern within the waveform, FIG. 13.

Having identified a rough arrival time for the mode associated with the model waveform and using dispersion curves as guidance, estimates for t₁ and t₂ can be made. Because each pipe size has associated dispersion curves, the waveform window location and width will vary with pipe size and wall thickness.

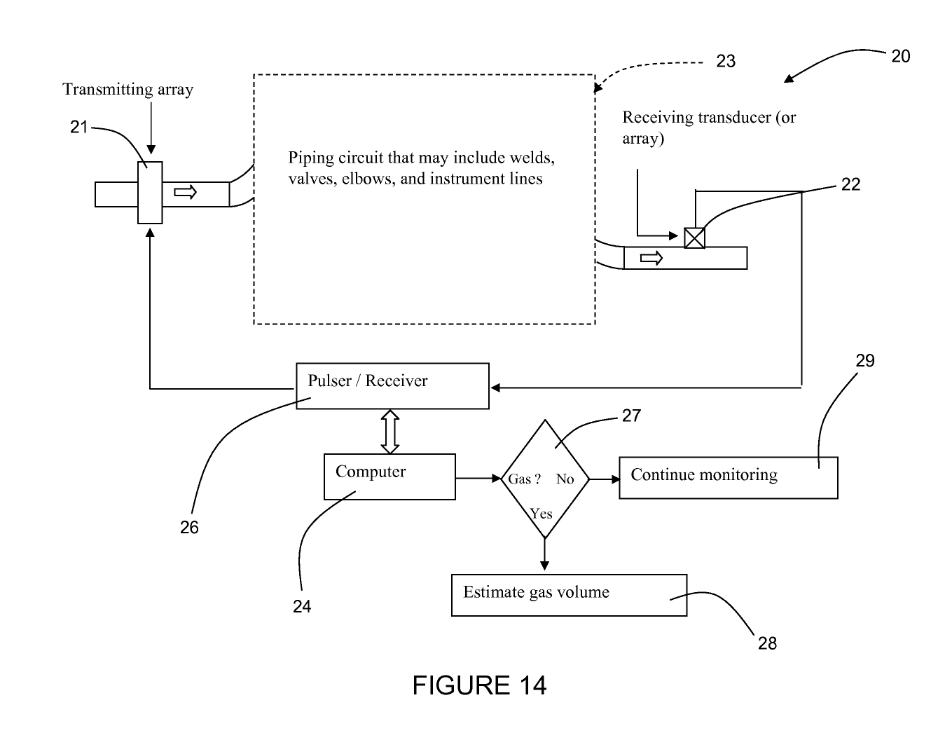

Referring now to FIG. 14, a gas entrapment detection system according to an embodiment of the invention is shown generally at reference numeral 20. The system 20 includes a transmitting array 21 and a receiver 22 positioned at different locations along a piping circuit 23.

The transmitting array 21 sends guided waves into the piping circuit 23 being monitored for gas entrapment. The mode(s) of the guided wave propagated are especially selected to provide for penetration distance and to have a component that “leaks” into the liquid that the piping system is transporting. Mode selection is based on the particular piping used for the system, e.g. carbon steel, 2 inch, schedule 10.

The receiver 22 receives the guided wave components that successfully traversed the piping circuit 23. If no liquid is in the circuit, most all of the input energy is received. On the other hand, if the piping circuit contains liquid, the leaky component of the guided waves will be absorbed by the liquid. The leakage amount is loosely proportional to the area of contact the liquid has with the interior wall of the piping circuit. An energy feature, is extracted from the received waveform. The principle behind this feature is that leakage reduces the transported energy.

A computer 24 acts as a controller and receives information from the transducer 22 via a pulser/receiver 26. The computer 24 analyzes the information and determines if there is gas in the circuit 23. If the answer is yes, Block 27, then the computer 24 estimates the gas volume, Block 28, in the circuit 23. If the answer is no, Block 27, the computer 24 instructs the transmitting array 21 to continue sending guided waves into the circuit 23 so that the computer can continue monitoring, Block 29, the guided wave components received by the transducer 22.

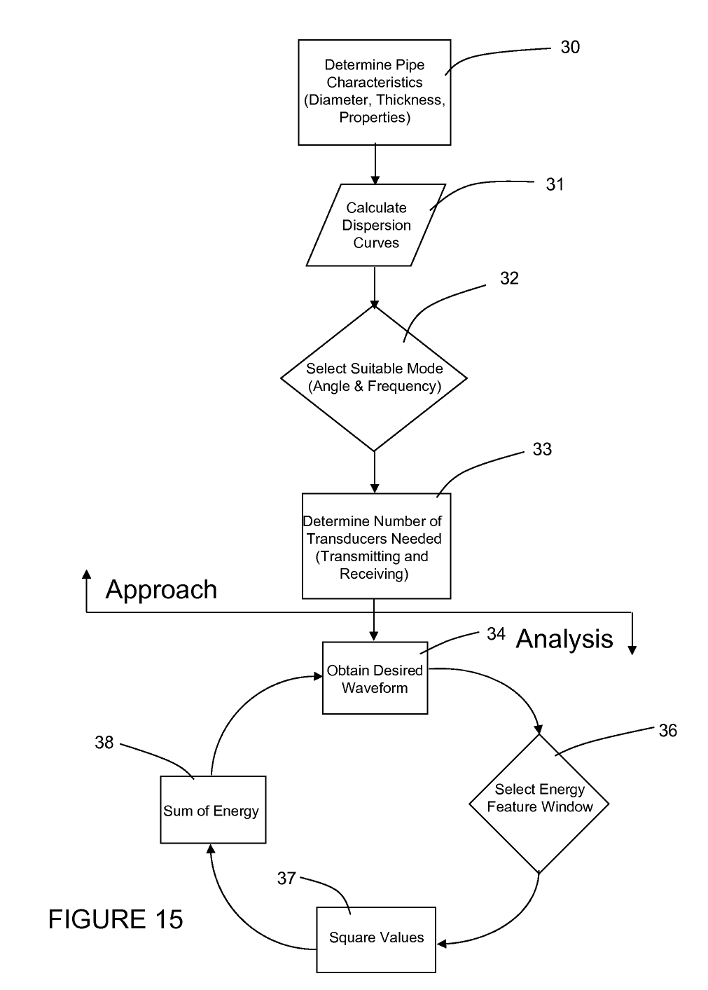

Referring to FIG. 15, the general method of detecting a gas void is as follows. First, a determination of pipe characteristics is performed, Block 30. The pipe characteristics include diameter, thickness, and material properties. Next, dispersion curves are calculated, Block 31, to represent the pipe being tested. A suitable mode is selected, Block 32, which determines angle and frequency. Further, based on the above, a determination of the number of transducers (transmitting and receiving) is made, Block 33. Once this has been done, the desired waveform is obtained, Block 34, by selecting an energy feature window, Block 36, squaring values, Block 37, and summing energy, Block 38.

Several tests were performed using the system 20 and method above, and are described in the examples below.

### Example 1

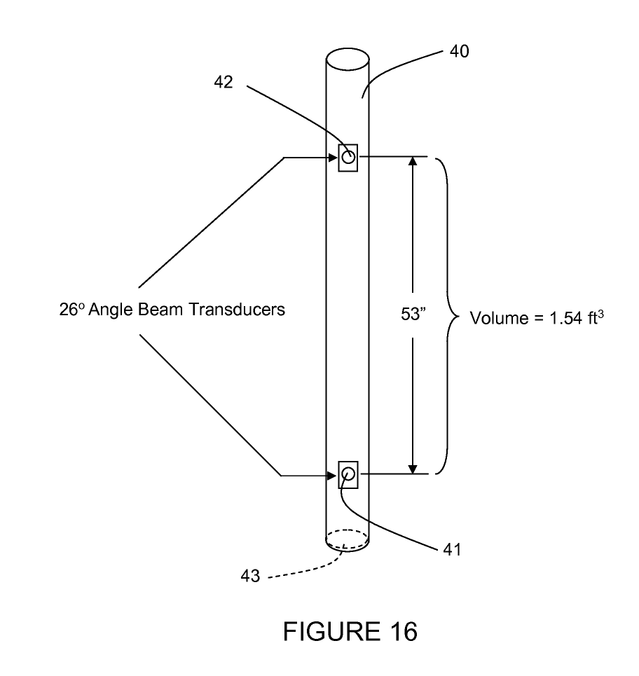

Referring to FIG. 16, a 4 inch, schedule 40 carbon steel pipe 40 was used to study the effect of water loading versus air loading on guided waves propagating through the pipe 40. The pipe 40 was filled with varying amounts of water and guided wave data was collected for correlation with different water volumes. It was observed that the group velocity of at least one mode was affected proportionately to the volume of water in the pipe 40. It was also noted that amplitude of at least one mode decreased exponentially with an increasing percentage volume of water filling the pipe 40.

The purpose of this experiment was to make use of two test points taken from a dispersion curve, one with maximum penetration power and one with maximum sensitivity. The objective was to find a test point (mode and frequency), that was not sensitive to water presence, and a second point that was less sensitive to water presence in a pipeline.

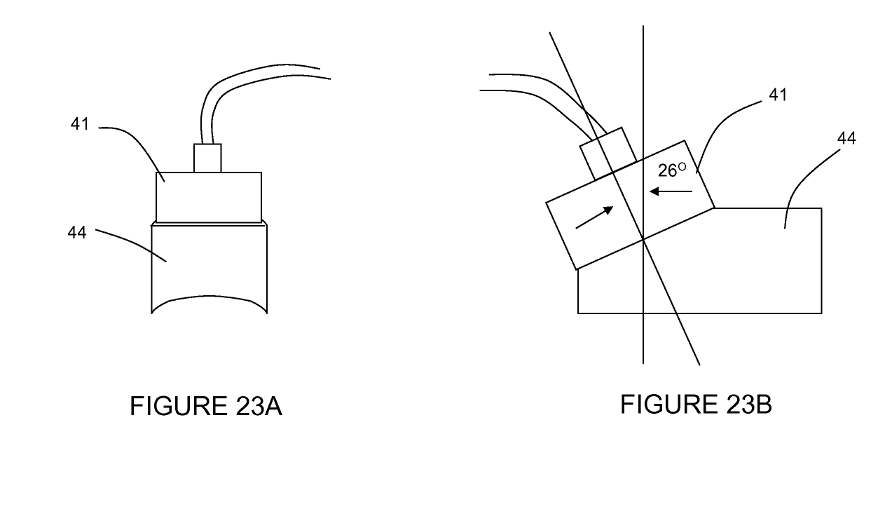

Transmitter 41 and receiver 42 were used in the through transmission mode to collect data from the pipe. The transmitter 41 and receiver 42 each use 500 kHz angle beam transducers to transmit and receive. The pipe 40 was positioned vertically as shown. The transmitter 41 and receiver 42 were mounted on 26° Plexiglas wedges 44, as shown in FIGS. 23A and B. The lower end of the pipe 40 was plugged with a rubber stopper 43. The transmitter 41 and receiver 42 were affixed to the outer surface of the pipe 40 with plastic ties. The transmitter 41 was placed 6 inches from the bottom of the pipe 40 and directed along the axial direction of the pipe 40. The receiver 42 was directed facing the transmitter 41 and was at an axially aligned 53 inches from the transmitter 41. The volume of pipe 40 spanning the transmitting and receiving transducers was 1.54 cubic feet [˜2,660 in³].

Data was taken in the following sequence: 0% water, 25% water, 55% water, 81% water and, 100% water. These percentages are based on the volume of water between the transmitter 41 and receiver 42. The transducer loading for each measurement was a 20-cycle toneburst signal averaged 99 times. Frequency was swept at each measurement point from 150 kHz to 900 kHz in 10 kHz increments. Frequency was tuned to an interesting response (e.g. a good response at 350 kHz, better at 353). A good response is associated with receiving a strong signal amplitude.

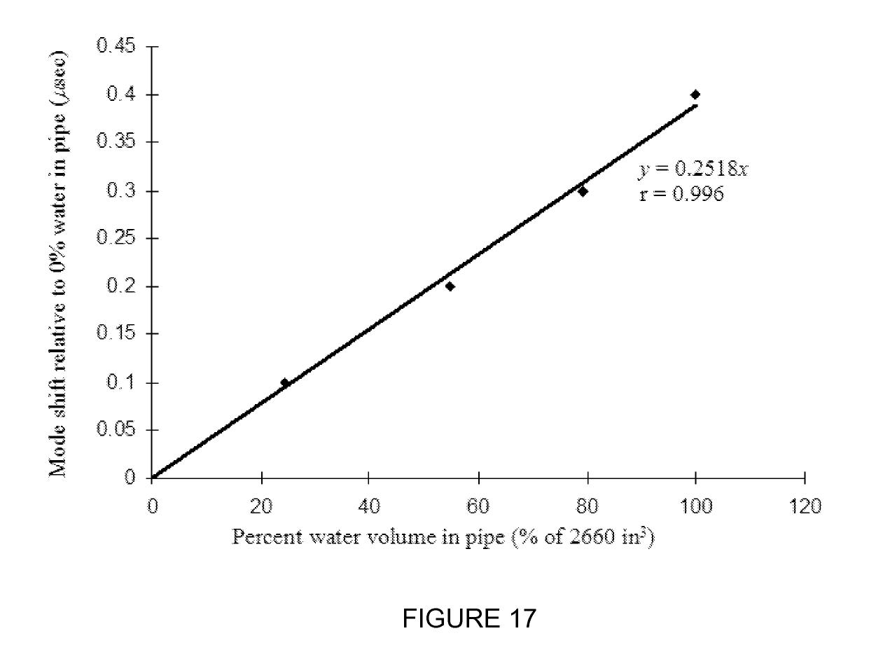

The data set from the 454 kHz excitation showed a positive correlation with water volume percentage. This mode (wave packet) appeared between 370 μsec and 415 μsec in each of acquired signals. The signals were cross-correlated within the same window with the 0% volume signal. Cross-correlation detects time shifts between signals. The arrival time of a mode measures its group velocity. Thus, time shifts show changes in group velocity. Table 2 shows the water volume and the time shifts, and FIG. 17 shows the microsecond shift as a function of water level in the pipe 40.

TABLE 2

| Water Volume | Time Shift |
|---|---|
| (percent) | (μsec) |
| 0% | 0 |
| 25% | 0.1 |
| 55% | 0.2 |
| 81% | 0.3 |
| 100% | 0.4 |

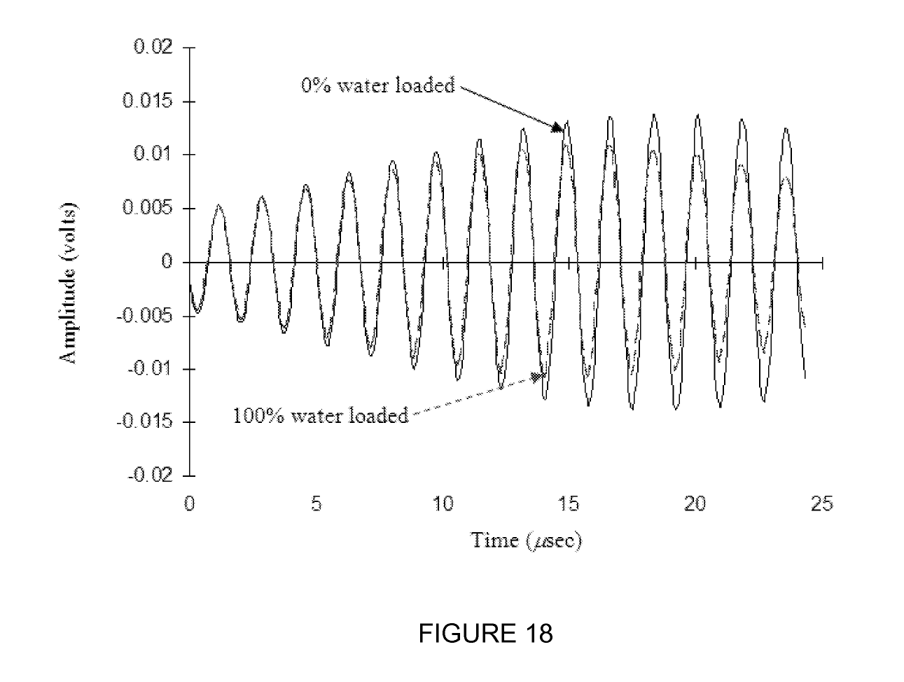

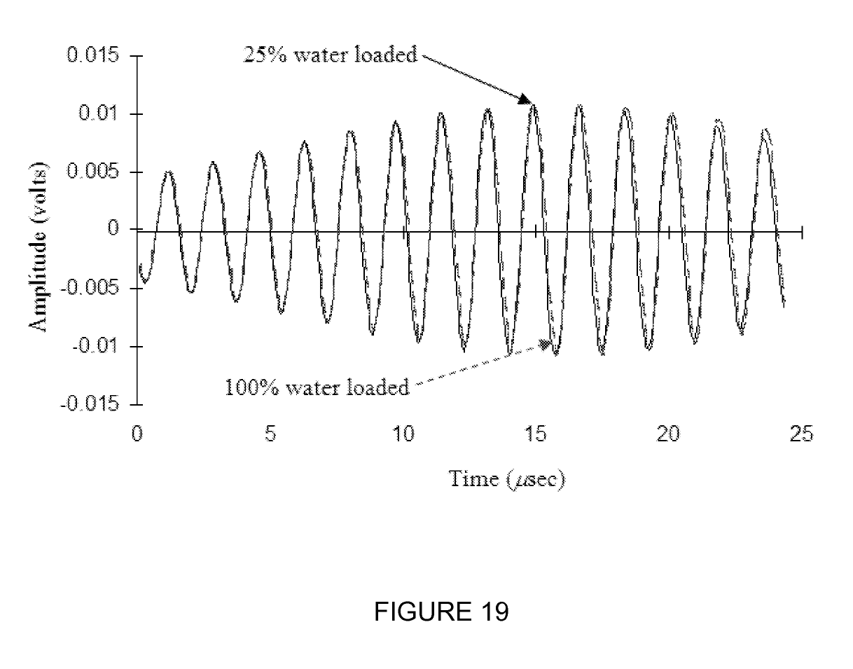

The fastest mode in the signal was at 585 kHz and did not exhibit a change as a function of water level in the pipe 30. FIG. 18 shows this fastest mode [585 kHz] for the reference signal superimposed with the same mode for the data set representing 100% of water over the transmitter. FIG. 19 shows the same representation of this mode for the data sets when there was 25% of water between the transmitter 41 and receiver 42 and when the pipe 40 was full of water.

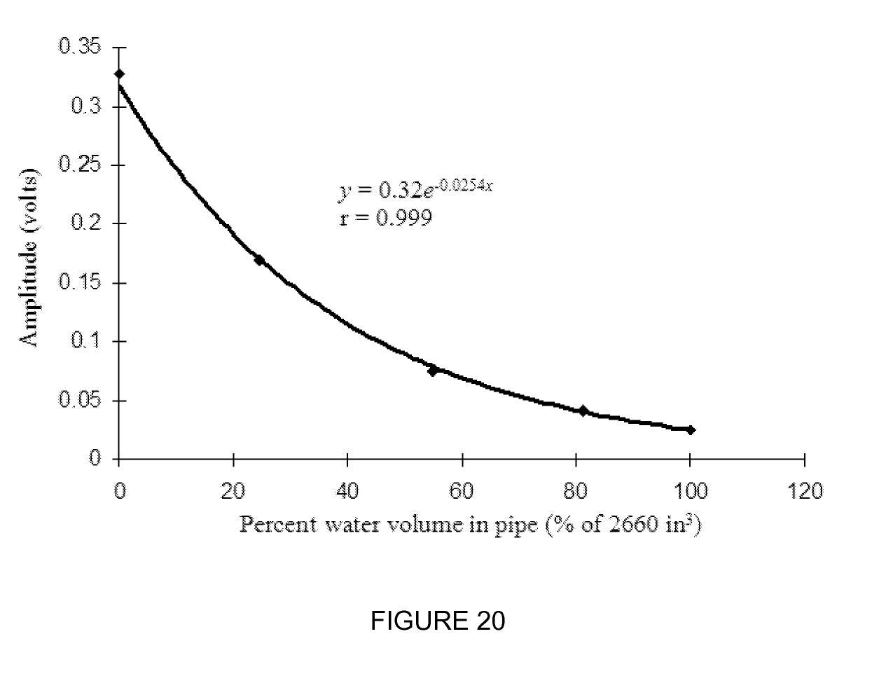

The amplitude of these two modes was also analyzed as a function of water volume in the pipe 40. The amplitude of the water sensitive mode decreased exponentially with an increasing volume of water in the pipe 40. A plot of amplitude versus water volume for this mode is shown in FIG. 20.

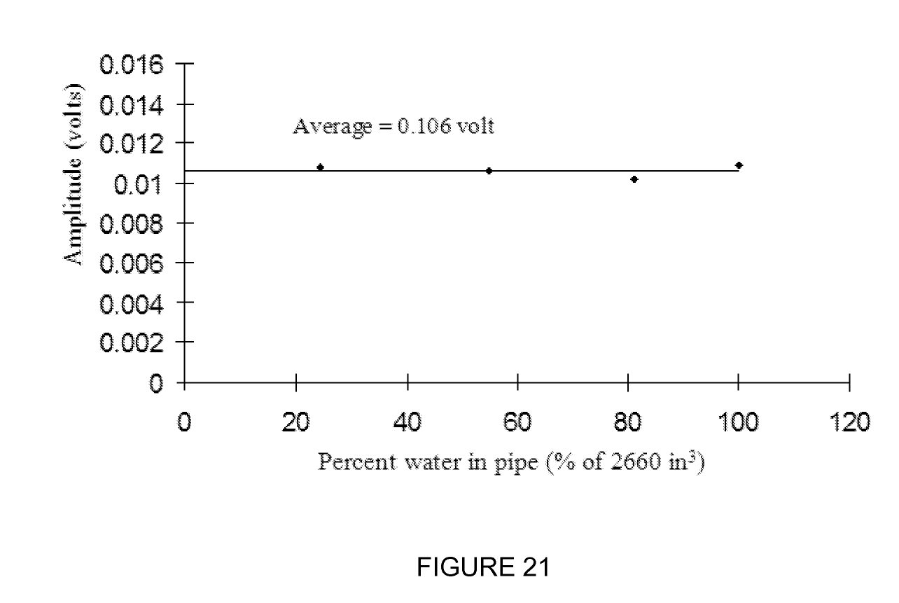

The amplitude of the 585 kHz mode was not sensitive to the water volume in the pipe 40 for volumes greater than zero. This mode did leak a small amount of energy into the water and this is demonstrated by the reduction in amplitude of the second data point relative to the first. A plot of the amplitude of this mode as a function of water volume in the pipe is shown in FIG. 21. Notice that a linear fit to data shows hardly any variation.

### Example 2

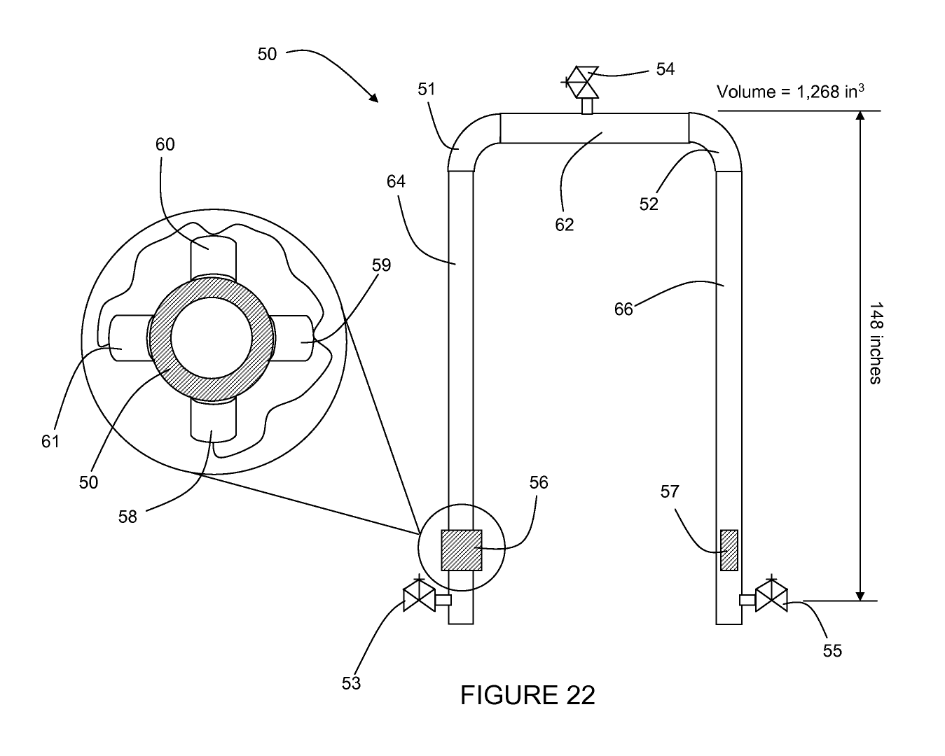

In a further study, a 2 inch, schedule 10 steel pipe 40, FIG. 22, was used to study the effect of water loading versus air loading on guided waves propagating through a U-shaped pipe 50. This design would allow researchers to understand the effects of wave propagation in the horizontal and vertical orientation. The mockup was allowed to swivel in order to study wave propagation through a strictly horizontal orientation or in the upright position which allows wave propagation through both the vertical and horizontal directions. The “U” shape design consisted of two elbows 51, 52 and three vent/drain valves 53-55 for control of the water level. Total length of the pipe was 314 inches.

A transmitter array 56 and a receiver 57 were used in the through transmission mode for the data collection. Two frequencies were used; 320 kHz and 400 kHz. Theoretical consideration indicates that these two frequencies would provide reasonable energy leakage into a fluid that would lead to a suitable algorithm for determining gas entrapment volume in the pipe 50. The pipe 50 was oriented vertically with a cross-member 62 at the top, as if it were an upside-down “U”. The transmitter array 56 includes four transmitters 58-61 each using 500 kHz transducers to excite quasi-axisymmetric waves into the pipe 50. The transmitters 58-61 and receiver 57 are mounted to Plexiglass like those shown in FIGS. 23A and B. This array 56 was mounted about 1 foot from one end of the pipe 50. The receiver also used a 500 kHz transducer to receive signals from the array 56. The receiver 57 was mounted at the other end of the pipe 50 about 18 inches from the pipe end. The distance between the transmitter array 56 and the receiver 57 was 23 feet. The volume of pipe between the transmitter array 56 and receiver 57 was 0.6 cubic feet.

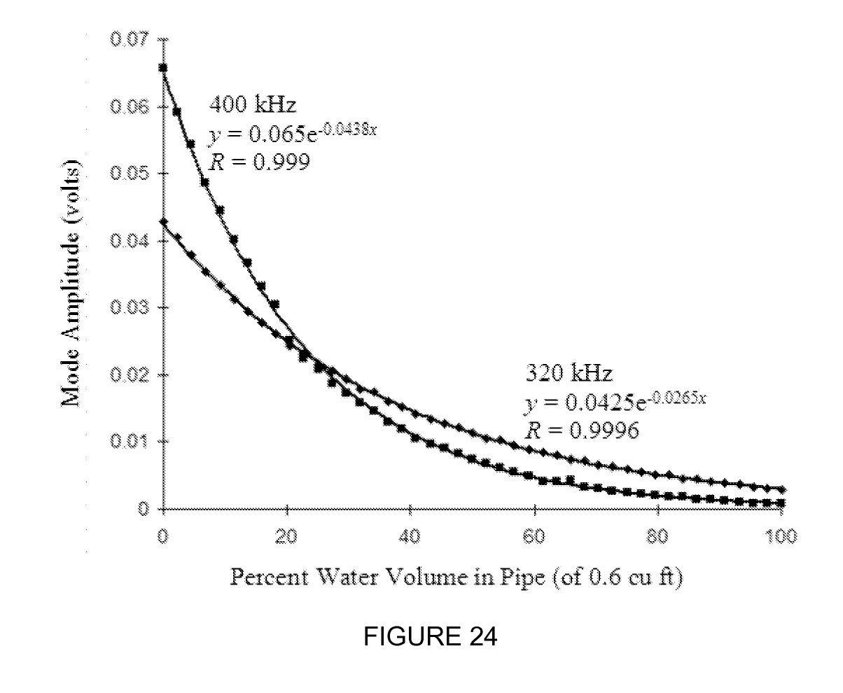

The pipe 50 was filled with water and ultrasonic signals were sent from the transmitter array 56 up a left vertical section 64 of the pipe 50, around the two elbows 51 and 52, and down a right side section 66 of the pipe 50 to the receiver 57. This was done with 320 kHz excitation, and again with 400 kHz excitation. A 20 cycle pulse was used to excite these waves. The incoming signal for each frequency was band pass filtered to a window of plus or minus 50 kHz from the excitation frequency. Following this test, 24 cubic inches of water was removed from the pipe 50 and the same signals were taken again. This process was repeated by removing 24 cubic inches of water at a time until all the water was removed from the pipe 50. The amplitudes of the fastest mode [Wave packet arriving first] of each signal was then measured and plotted as a function of the water level in the pipe 50, FIG. 24.

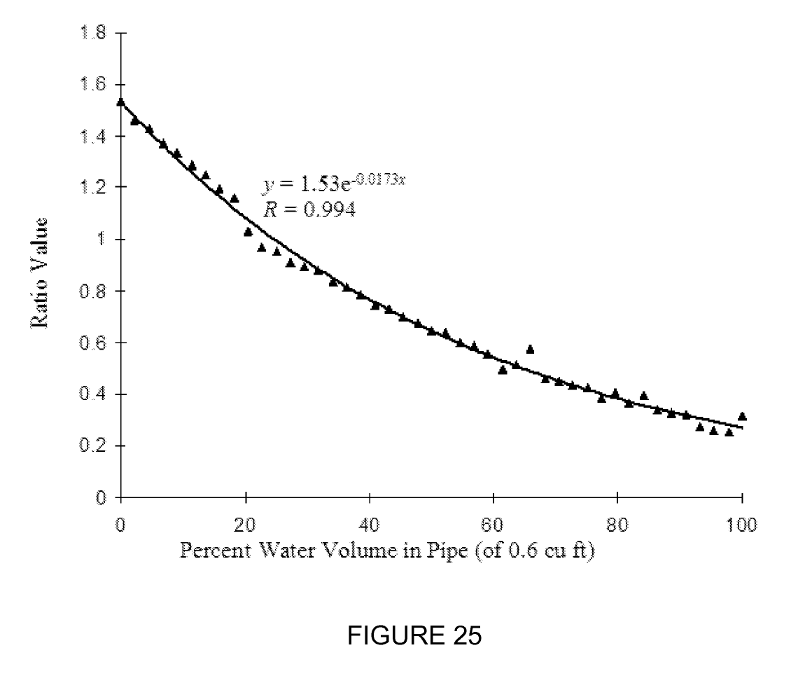

For both the 320 kHz and the 400 kHz excitations, the amplitude of the fastest mode in each signal increased as water was removed from the pipe 50. The amplitudes grew exponentially and correlated very closely with a least-squares exponential fit. The amplitudes of the 320 kHz signals as a function of water loading superimposed with those for the 400 kHz loading are shown in FIG. 24. The ratio of the amplitudes of the 400 kHz signals to the amplitudes of the 320 kHz signals was also computed. A plot of this ratio is shown in FIG. 25. It was observed that the guided waves were affected differently by the water in the horizontal cross member 62 of the pipe 50 than they were in the vertical sections 64, 66 of the pipe 50. This is seen in the deviation from the trend of the right-most four points in FIG. 25.

The circumferential profile (guided wave energy distribution around the pipe) at the receiver 57 was also measured. This was done using 320 kHz excitation. Measurements were taken at the receiver location at each of eight equally-spaced angular locations. The amplitude of the 585 kHz mode was not sensitive to the water volume in the pipe 50 for volumes greater than zero. This mode did leak a small amount of energy into the water as demonstrated by the reduction in amplitude of the second data point relative to the first.

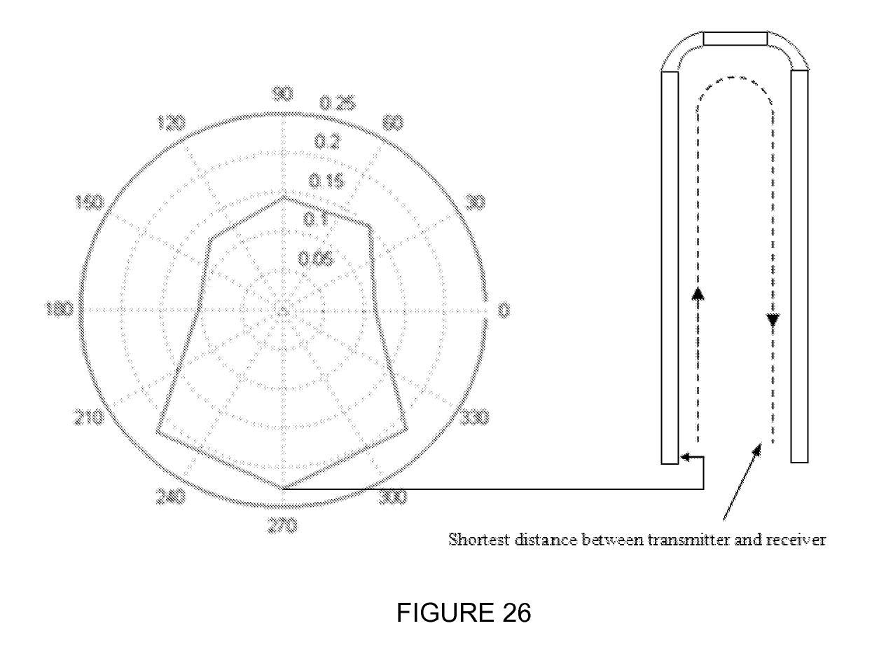

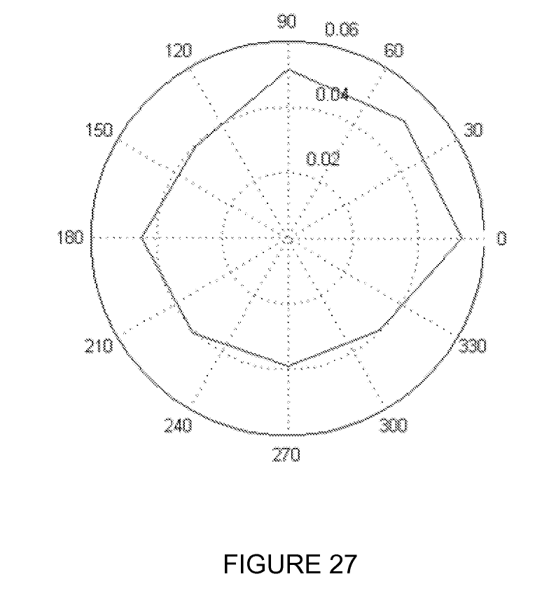

The profile at the receiver location was mostly axisymmetric, but did show slight asymmetry when the pipe 50 was empty. FIG. 26 shows the circumferential profile for the empty pipe 50, and FIG. 27 shows the same for the pipe 50 when it was full of water. The 270 degrees location in the plots represents the portion of the right leg that was closest to the left leg 64, that is, the inside of the “U”. This represents the shortest pathway between the transmitter 56 and the receiver 57.

### Example 3

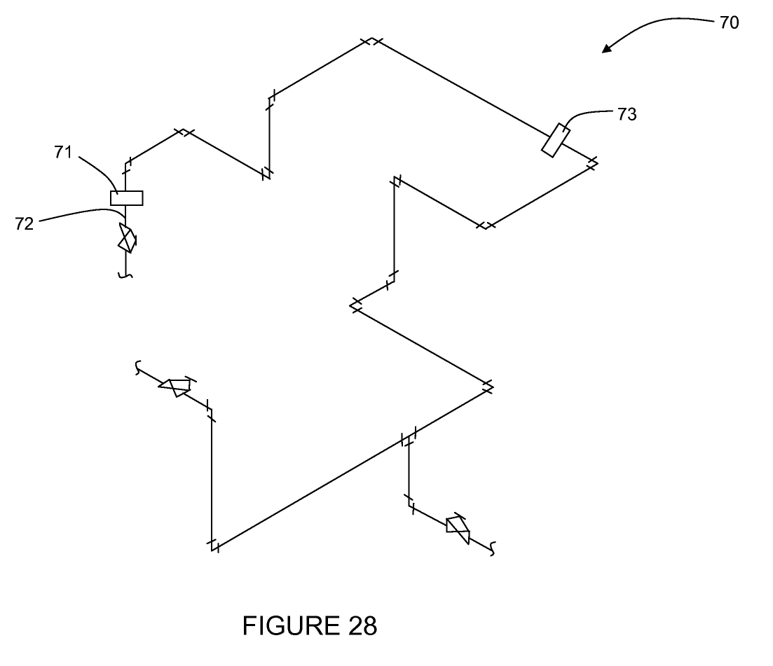

After performing the above test described in Examples 1 and 2, a mockup of a piping circuit 70, FIG. 28, in the field was constructed. The piping circuit 70 was constructed out of 2 inch, schedule 40 carbon steel pipe with 90° long radius elbows.

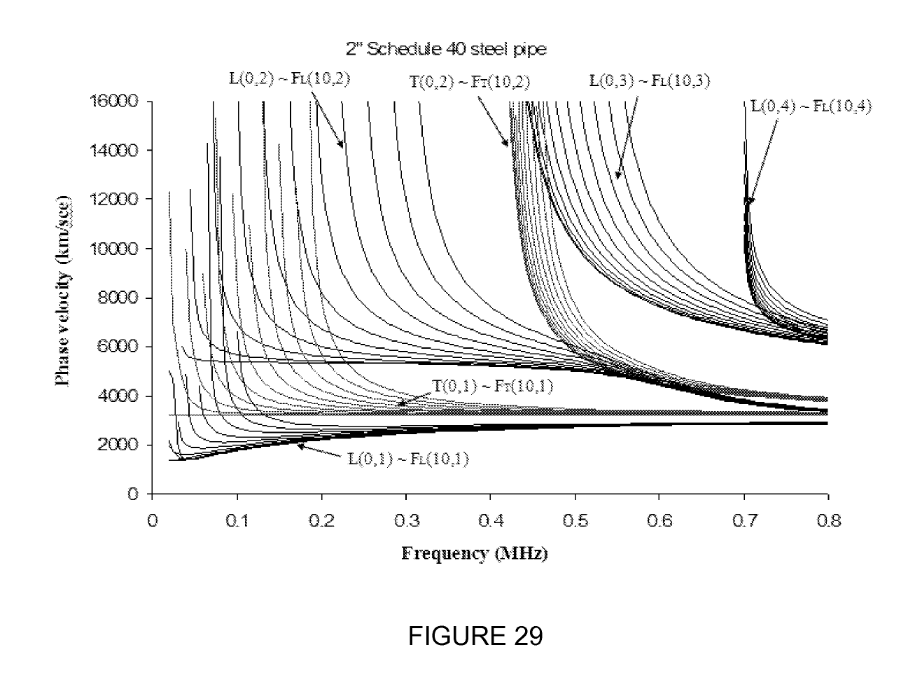

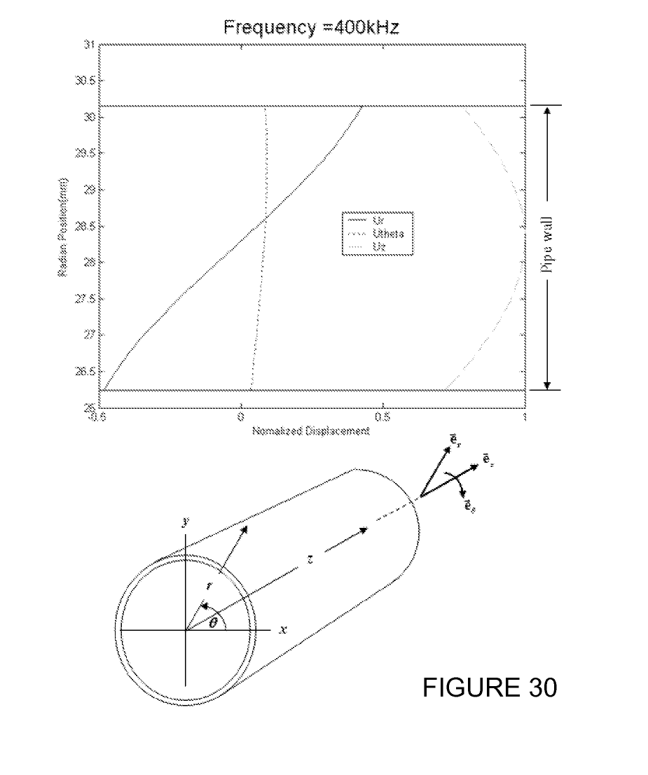

Because pipe wall thickness is a critical parameter for dispersion curve generation, wave structure, and subsequent probe design, new dispersion curves, FIG. 29, had to be generated to match the circuit 70. A test point with a displacement on the inside surface was selected that could be useful for the gas intrusion problem. From these curves, the wave structure at 400 kHz exhibited large displacements on both the exterior and interior pipe walls, FIG. 30. The interior radial (out-of-plane) displacement is important for detecting gas (water absorbs the displacement energy, gas does not).

Likewise, the interior portion of the large axial (z-direction, dashed green) displacement should also be affected by the gas-to-water ratio within the pipe circuit 70, FIG. 30. For example, the T (0,1) mode would have no leaky wave component, hence insensitivity to water presence. The L (0, 2) curve at lower frequency 0 to 500 kHz has a dominant non leaky component, but because the phase velocity spectrum and frequency spectrum are somewhat broad, there is a leaky component.

Transducers were excited at three frequencies, 150 kHz, 350 kHz, and 500 kHz in the through transmission mode. Of these, the 150 kHz provided the best correlation with air volume.

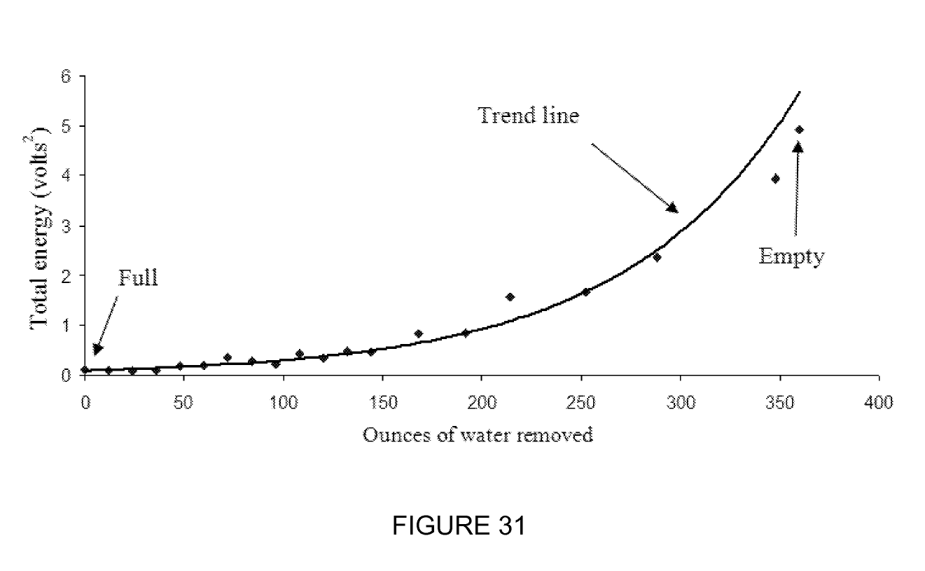

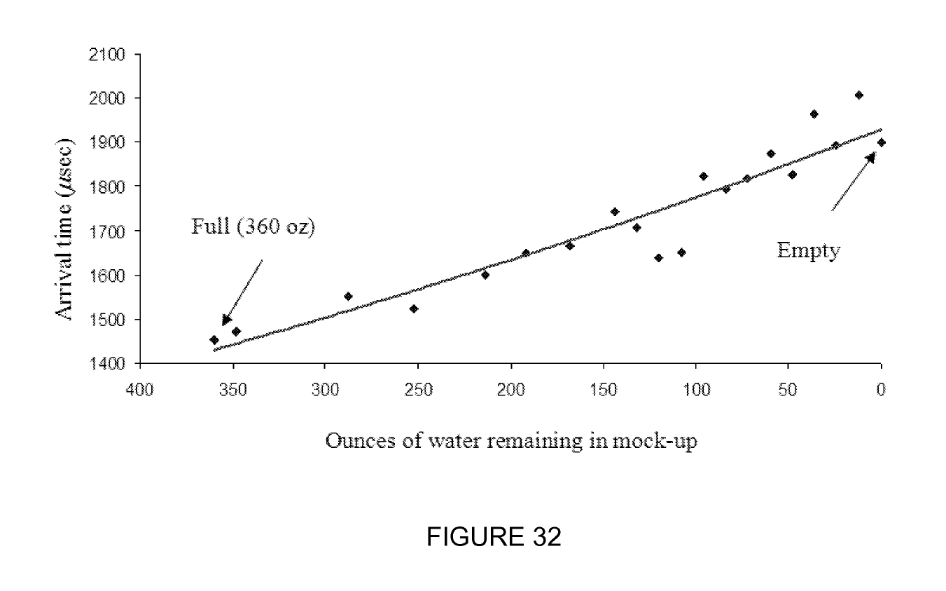

A series of tests were carried out on the pipe circuit 70 to determine the effects of air pocket size on the guided wave signal. Two guided wave signal features were identified as promising candidates for predicting air pocket size. An energy feature described below was used to show that a trend exists relating the total received guided wave energy to the size of the air pocket existing in the loop. Energy is calculated by generating the analytic envelope of the received RF waveform and squaring each value. It was shown that signal arrival time could be used to predict air pocket size. FIGS. 31 and 32 show the curves generated for each feature as a function of air pocket size in the test loop.

One feature is the running sum of the energy starting within a user defined window and the other the total energy within that window.

$$RF signal a ( {t}_{1} ) , a ( {t}_{2} ) , … , a ( {t}_{N} )$$

$$Analytic envelope e ( {t}_{1} ) , e ( {t}_{2} ) , … , e ( {t}_{N} )$$

$$Squared values {e ( {t}_{1} )}^{2} , {e ( {t}_{2} )}^{2} , … , {e ( {t}_{N} )}^{2}$$

$$Running sum S ( {t}_{J} ) = {\sum e}_{j = 0}^{J} {( {t}_{j} )}^{2} -> Feature 1$$

$$Total energy = S ( {t}_{N} ) -> Feature 2$$

$$Running sum S ( {t}_{J} ) = {\sum }_{j = 0}^{J} {e ( {t}_{j} )}^{2} -> Feature 1$$

Running energy is calculated as a function of time. In the final decision algorithm on gas entrapment volume, one time will be selected to draw a conclusion. All times may not work because of mode conversion, reflection factors, and sensitivity difference for different modes and frequencies that finally propagate in the pipe circuit 70.

To make gas entrapment detection even stronger, additional features such as arrival time waveforms may be used, FIG. 32. These time values were measured against a 0.01 volt threshold. The trend for arrival time to decrease with increased air content is obvious. Arrival time decrease means that the wave velocity is increasing, most likely due to more interaction with gas compared to water. Hence, energy and/or wave velocity could be useful.

A transmitter array 71 of four transmitters was placed on a vertical section 72 of circuit 70 in the location shown in FIG. 28. A receiver 73 was placed at a separate point along the same circuit 70, as shown in FIG. 28. Approximately 270 inches of pipe and five elbows were between the transmitter array 71 and receiver 73. The circuit 70 was empty and a baseline data set was acquired.

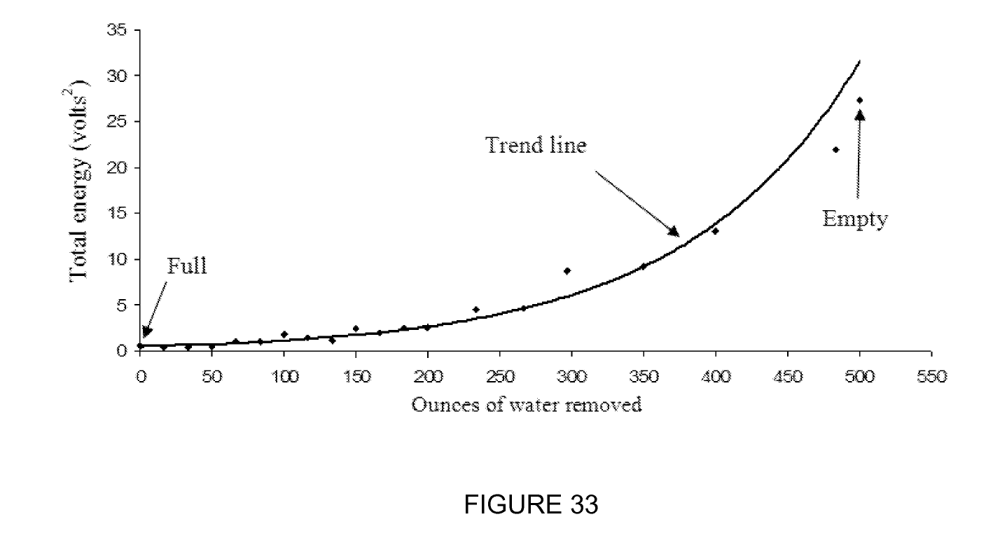

An analysis was carried out to predict the results. The signal arrival time of the signal obtained on the empty pipe loop was determined to be 1420 μs. This value was determined by recording the first data point exceeding an amplitude value of 0.01 V, or ˜10% of the maximum received signal. Note that the 0.01 V threshold analysis being used here is the same as used and reported in the previous experiments. Using the same threshold analysis, the arrival time of the waveform acquired is ˜2313 μs. The energy vs. air pocket size plot shown in FIG. 31, comprised of data acquired on the pipe loop, used total energy calculated for each waveform in the time window of 1250-2000 μs, or +580 μs and −170 μs from the calculated arrival time. Using these plus or minus values, a window for evaluating the data could be chosen as 2143-2893 μs. Using this time window, the total energy for the empty pipe loop is 27.25 V². Now, an energy vs. gas pocket size chart can be constructed via extrapolation using the data acquired on the circuit 70. The data acquired on the empty circuit 70 is shown in FIG. 33. A trend exists here relating air pocket size to total energy received through the circuit 70. More energy is received if more gas is encountered by the ultrasonic wave as it travels from the transmitter array 71 to the receiver 73.

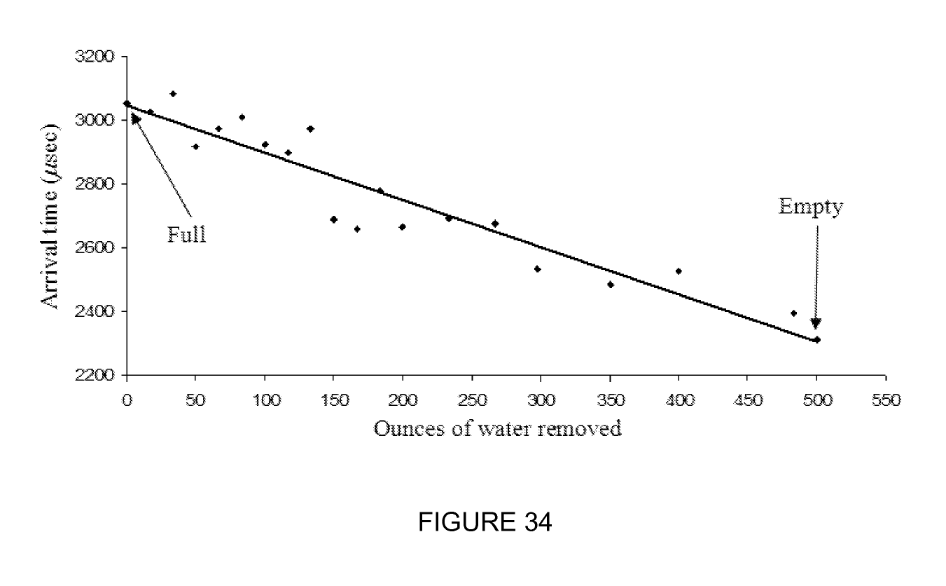

Similarly, extrapolation can be used to construct an arrival time vs. gas pocket curve, as shown in FIG. 34. A trend also exists here relating air pocket size to signal arrival time through the circuit 70, i.e., the wave travels faster when air is encountered and slower when water is encountered.

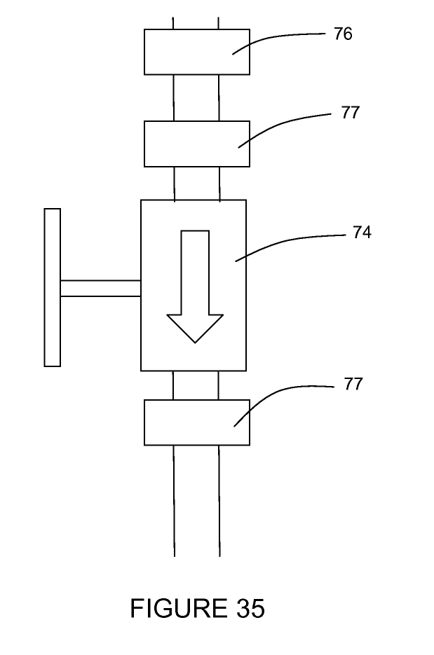

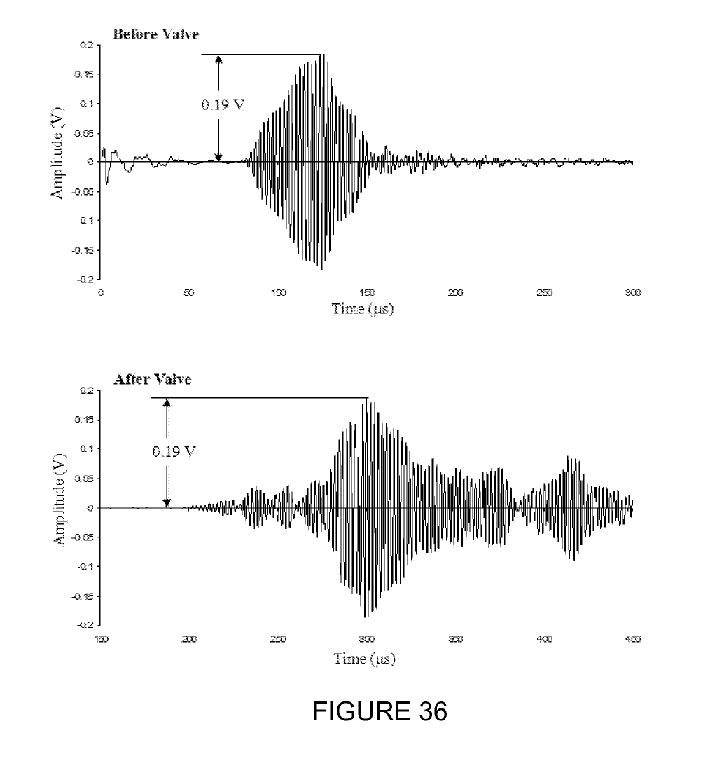

As shown in FIG. 35, signal attenuation due to a “large” valve in the circuit 70 was studied. Transmitters 76 were placed approximately 12 inches above valve 74 to send ultrasonic energy down the pipe in the direction shown. Excitation frequency was 150 kHz. A receiver 77 was placed directly in front of the valve 74 and then directly behind the valve 74 to determine the valve's effect on the RF signal. RF waveforms acquired when placing the receiver directly in front of and behind the valve are shown in FIG. 36.

As shown in FIG. 36, 24.5 dB more receiver gain was needed to amplify the “after valve” waveform to the same level as the “before valve” waveform, i.e., the valve attenuates the guided wave signal by 25 dB.

### Example 4

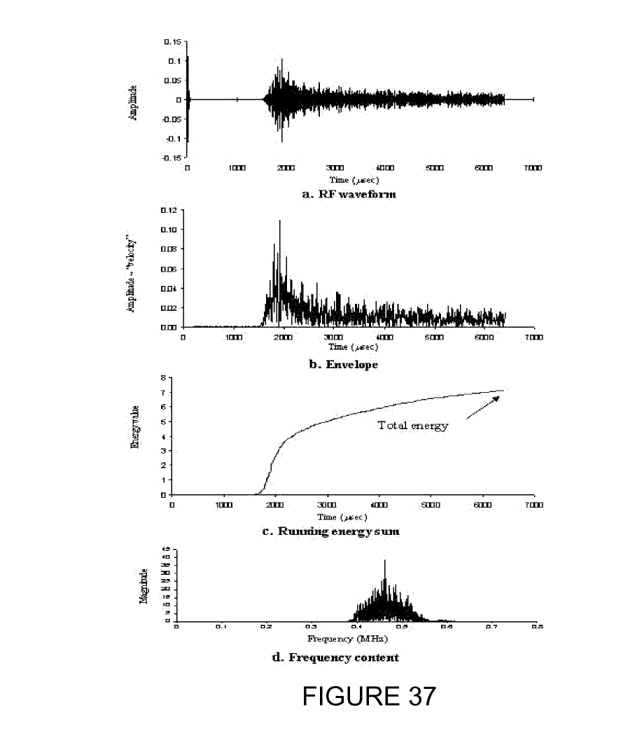

Additional tests were performed on the U-shaped pipe 50. Emphasis was placed on smaller volumes of air. The pipe 50 was filled with water and allowed some settling time. Thus 0% air was in the pipe 50. Total volume of the liquid filled pipe 50 from the transmitter 56 to the receiver 57 was 1,268 in³. Water was sequentially removed in 20 in³ increments or a 1.6% water removal step (1.6% air void). A sample waveform, envelope, and the energy running sum are presented in FIG. 37 [470 kHz excitation]. Two frequencies were analyzed including 170 kHz and 470 kHz.

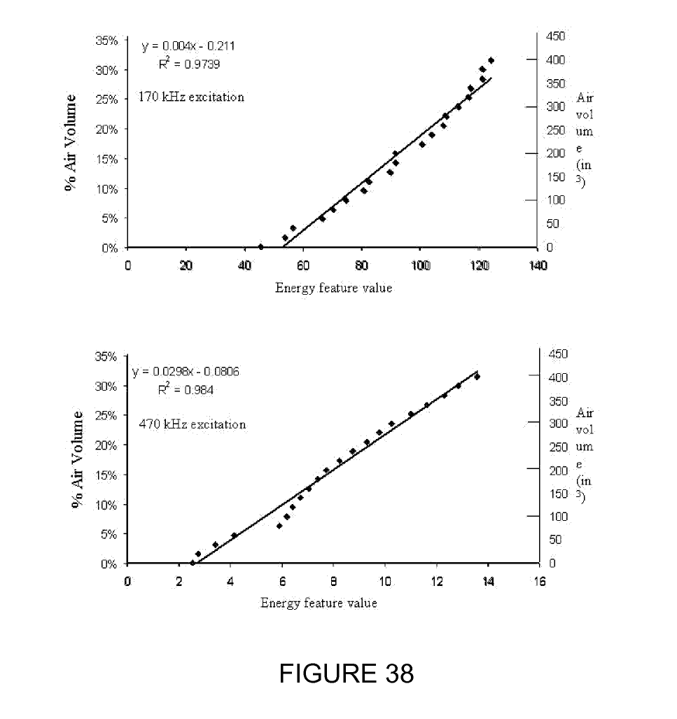

FIG. 38 shows the results of these experiments. Note the R² value, coefficient of determination is very high for both the 170 kHz case and for the 470 kHz case. The results show that guided wave is able to detect small changes in water volume. Although this is only one pipe diameter, the pipe 50 in which this sensitivity study was conducted proves more challenging than larger diameter pipes. Experience has shown that by selecting the right envelope on the RF waveform, larger diameter pipes will be more sensitive to changes in water volume.

### SUMMARY

By transmitting sound energy over a range of pipe, the total energy received is a function of the amount of water in the system. The more water in the pipe, the less energy that is received due to the amount of sound energy leaking into the fluid (i.e. a dry pipe will have a stronger signal than a water solid (or 100% full) pipe).

The amount of energy received is also dependent on the system configuration. Pipe orientation (vertical, horizontal, or combination of both) appears to have little effect on energy transmitted. Energy will pass through a limited amount of elbows. Small vent valves (typically ¾″) also have little effect on the energy which is reassuring because a majority of the emergency core cooling systems (EGGS) will have vent valves installed in high points. Pipe insulation is required to be removed only at the point of contact of the transmitters and receivers.

Because guided wave has the ability to be permanently installed, a one time calibration procedure may be used for accurate detection and quantification of gas voids. Calibration includes taking readings on a full (water solid), empty, and partial filled pipe. This calibrating process should be good for the life of the system assuming that the transmitters and receivers are always mounted at the same location and no changes to the pipe's configuration or geometry is warranted.

Guided wave may also be used for on-line monitoring or for temporary attachment to piping for verification of water solid pipe. Sensors could be permanently installed and lead wires routed into a convenient location. Periodic checks could then be rapidly acquired to detect the presence of gas. This type of monitoring would limit insulation removal and reduce total man-hours and dose exposure. Additionally, the time spent in containment is minimized and the need for scaffolding is reduced.

The ability to inspect longs runs of pipe with guided wave also has significant advantages as compared to normal beam ultrasonics which is only good for point spot identification of gas voids. The high point on a piping section may be in excess of 20 feet in length and may require multiple spot checks to locate a gas void. Performing manual spot checks can likely be time consuming however, the number of spot checks should decrease with experience. Likewise, pipe access may be limited or in extreme cases inaccessible. With the ability to monitor long lengths of pipe, the device is not dependent on accessibility as is normal beam ultrasonics.

The foregoing has described a system and method of detecting gas voids using guided wave. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

We claim:

1. A gas detection system, comprising:
(a) a transmitter positioned at a designated point on a piping circuit and adapted to transmit guided waves into the piping circuit;
(b) a receiver positioned at a designated point distant from the transmitter and adapted to receive the guided waves transmitted through the piping circuit by the transmitter; and
(c) a computer for analyzing and monitoring the guided waves received by the receiver.

2. The gas detection system according to claim 1, wherein the transmitter includes a transducer for transmitting the guided waves into the piping circuit.

3. The gas detection system according to claim 1, wherein the receiver includes a transducer for receiving the guided waves transmitted through the piping circuit.

4. The gas detection system according to claim 1, wherein the transmitter and receiver each include a broadband angle beam transducer to transmit and receive the guided waves.

5. The gas detection system according to claim 1, wherein the transmitter is a transmitter array including a plurality of transducers adapted to transmit the guided waves into the piping circuit.

6. The gas detection system according to claim 1, wherein the transmitter is selected from the group consisting of a single transducer probe, an array of transducers, and a plurality of transducers.

7. A method of detecting gas in a piping circuit, comprising the steps of:
(a) calculating a set of dispersion curves for the piping circuit;
(b) using a gas detection system to transmit guided waves into the piping circuit;
(c) using the gas detection system to receive the guided waves transmitted into the piping circuit; and
(d) using the gas detection system to determine an amount of gas in the piping circuit.

8. The method according to claim 7, wherein the gas detection system includes a computer adapted to analyze and monitor the guided waves being received by the gas detection system.

9. The method according to claim 8, further including the step of using the computer to instruct the gas detection system to transmit guided waves into the piping circuit in the event that no amount of gas is determined to be in the piping circuit to allow the computer to monitor the piping circuit for gas.

10. A method of detecting gas in a piping circuit, comprising the steps of:
(a) providing a gas detection system having:
(i) a transmitter;
(ii) a receiver;
(iii) a computer;
(b) calculating dispersion curves for the piping circuit;
(c) using the transmitter to transmit guided waves into the piping circuit;
(d) using the receiver to receive the guided waves transmitted through the piping circuit;
(e) using the computer to calculate an analytic envelope;
(f) using the computer to calculate energy; and
(g) determining an amount of gas contained in the piping circuit.

11. The method according to claim 10, further including the step of calculating an angle of incidence for the transmitter.

12. The method according to claim 10, further including the step of determining a guided wave mode from the dispersion curves.

13. The method according to claim 10, wherein the analytic envelope is calculated using a Hilbert transform of the guided waves received by the receiver.

14. The method according to claim 10, wherein the energy is calculated by integrating over time the square of the analytic envelope.

15. The method according to claim 12, further including the step of determining a number of transmitters and receivers to be used on the piping circuit from the determined guided wave mode.

16. The method according to claim 11, wherein the angle of incidence is calculated using Snell's law.

17. The method according to claim 10, further including the step of determining piping circuit characteristics.

18. The method according to claim 17, wherein the piping circuit characteristics are selected from the group consisting of pipe diameter, pipe wall thickness, and pipe material properties.
